(19) United States
(12) Patent Application Publication
(10) Pub. No.: US 2014/0159516 A1
(43) Pub. Date: Jun. 12, 2014

(54) SWITCHED RELUCTANCE MOTOR ASSEMBLY

(71) Applicant: SAMSUNG ELECTRO-MECHANICS CO., LTD., Suwon (KR)

(72) Inventors: Jin Su Seok, Suwon (KR); Jin Wook Baek, Suwon (KR); Hyun Taek Ahn, Suwon (KR); Young Bok Yoon, Suwon (KR)

(21) Appl. No.: 13/933,504

(22) Filed: Jul. 2, 2013

(30) Foreign Application Priority Data
Dec. 6, 2012 (KR) 10-2012-0141346

(51) Int. Cl. H02K 7/04; H02K 1/24; H02K 9/06; H02K 29/06; H02K 29/10

(52) U.S. Cl. CPC H02K 7/04; H02K 29/06; H02K 29/10; H02K 9/06; H02K 1/246
USPC 310/43; 310/68 B; 310/62; 310/46

(57) ABSTRACT

Disclosed herein is a switched reluctance motor assembly, wherein a lower balancing part, which becomes a target to be cut for balancing, includes a lower balancing part body installed on a lower surface of a rotor part and an encoder protruding on a lower surface of the lower balancing part body. In the present invention, the encoder, which is a portion of a balancing part, becomes a target to be cut, thereby making it possible to more effectively perform balancing even with a smaller amount of cutting as compared with the prior art.

### CROSS REFERENCE TO RELATED APPLICATION

This application claims the benefit of Korean Patent Application No. 10-2012-0141346, filed on Dec. 6, 2012, entitled “Switched Reluctance Motor Assembly”, which is hereby incorporated by reference in its entirety into this application.

### BACKGROUND OF THE INVENTION

1. Technical Field

The present invention relates to a switched reluctance motor assembly.

2. Description of the Related Art

Generally, a switched reluctance motor (SRM) called an SR motor is a motor in which both of a stator and a rotor have a magnetic structure, which is a salient pole, the stator has a concentrated type coil wound therearound, and the rotor is configured only of an iron core without any type of excitation device (a winding or a permanent magnet), such that a competitive cost is excellent.

More specifically, the switched reluctance motor (SRM), which rotates a rotor using a reluctance torque according to a change in magnetic reluctance, has a low manufacturing cost, hardly requires maintenance, and has an almost permanent lifespan due to high reliability. The switched reluctance motor is configured to include: a stator part, which is a stator, including a stator yoke and a plurality of stator salient poles protruding from the stator yoke; and a rotor part, which is a rotor, including a rotor core and a plurality of rotor salient poles protruding from the rotor core so as to face the stator salient poles and rotatably received in the stator part.

Meanwhile, a balancing part includes the rotor part and is formed to enclose a shaft. The balancing part may be integrally molded and manufactured through injection molding so as to be filled in an annular rotor core of the rotor part. As a balancing method, a method of cutting a portion of the balancing part in order to maintain balance at the time of rotation of the motor is used. An impeller part may be stably rotated by the balancing part. Here, the balancing part includes upper and lower balancing parts installed on upper and lower surfaces of the rotor parts, respectively. Since the structure of the switched reluctance motor as described above has been well-known as disclosed in the following Patent Documents, a detailed description and illumination thereof will be omitted.

Meanwhile, a switched reluctance motor according to the prior art has a configuration in which a position of the rotor core of the rotor part is recognized by installing an encoder on a lower surface of the lower balancing part and then recognizing the encoder by a sensing part.

However, since the encoder according to the prior art as described above is installed separately from the lower balancing part, at the time performing cutting for removing an amount of eccentricity, only the balancing part is cut, such that a larger amount should be cut.

That is, since the encoder is disposed so as to be distant from the center axis, when the encoder is cut, balancing may be performed even with a small amount of cutting. However, according to the prior art, since the balancing part is separately disposed, a large amount of cutting should be performed.

### PRIOR ART DOCUMENT

### Patent Document

(Patent Document 1) U.S. Pat. No. 4,011,624
(Patent Document 2) U.S. Pat. No. 4,920,608
(Patent Document 3) U.S. Pat. No. 6,125,498

### SUMMARY OF THE INVENTION

The present invention has been made in an effort to provide a switched reluctance motor assembly capable of promoting balancing even with a small amount of cutting by forming an encoder for recognizing a position of a rotor core as a portion of a lower balancing part.

According to a preferred embodiment of the present invention, there is provided a switched reluctance motor assembly including: a shaft forming the center of rotation of a motor; a rotor part rotatably coupled on the shaft; an upper balancing part and a lower balancing part installed on upper and lower surfaces of the rotor part, respectively; and a sensing part disposed at one side of the lower balancing part, wherein the lower balancing part, which becomes a target to be cut for balancing, includes a lower balancing part body installed on the lower surface of the rotor part and an encoder protruding on a lower surface of the lower balancing part body, and the sensing part including a transmitting part and a receiving part spaced apart from each other so that the encoder passes therethrough.

According to another preferred embodiment of the present invention, there is provided a switched reluctance motor assembly including: a shaft forming the center of rotation of a motor; a rotor part rotatably coupled on the shaft; an upper balancing part and a lower balancing part installed on upper and lower surfaces of the rotor part, respectively; and a sensing part disposed at one side of the lower balancing part, wherein the lower balancing part, which becomes a target to be cut for balancing, includes a lower balancing part body installed on the lower surface of the rotor part and an encoder protruding on a lower surface of the lower balancing part body and having reflecting parts formed on one side thereof, and the sensing part is disposed at one side of the encoder and includes a light emitting part irradiating light to the reflecting part and a detecting part detecting light reflected from the reflecting part.

The encoder, which protrudes on the lower surface of the lower balancing part body, may include: a base having a hollow cylindrical shape and having a radius larger than that of the lower balancing part body; and a plurality of slot blocking parts protruding on a lower surface of the base, having an arc shape with a predetermined angle, and formed to be spaced apart from each other to pass through a slot of the sensing part.

The encoder, which protrudes on the lower surface of the lower balancing part body, may include: a base having a hollow cylindrical shape and having a radius larger than that of the lower balancing part body; and a plurality of slot blocking parts protruding on a lower surface of the base, having an arc shape with a predetermined angle, formed to be spaced apart from each other, and having reflecting parts formed on one side thereof.

The encoder, which protrudes on the lower surface of the lower balancing part body, may include: a base having a hollow cylindrical shape and having a radius larger than that of the lower balancing part body to pass through a slot of the sensing part; and a plurality of slot communicating parts disposed along a side of the base in a circumferential direction, formed to penetrate through the base a predetermined length in the circumferential direction, and spaced apart from each other.

The encoder, which protrudes on the lower surface of the lower balancing part body, may include a base having a hollow cylindrical shape, having a radius larger than that of the lower balancing part body, and having the reflecting part formed on an inner side thereof.

The switched reluctance motor assembly may further include: an upper bearing part coupled to an upper portion of the upper balancing part disposed on the rotor part; a lower bearing coupled to a lower portion of the lower balancing part; a front part supporting the upper bearing; a diffuser part coupled to an upper portion of the front part; and an impeller part coupled to an upper portion of the diffuser part and coupled to the shaft.

The switched reluctance motor assembly may further include: a housing part enclosing an outer side of the rotor part and formed to include the upper bearing and the lower bearing; and a cover part coupled to an upper portion of the housing part.

The lower balancing part and the encoder may be formed integrally with each other by injection-molding.

The rotor part may include an annular rotor core and a plurality of rotor poles protruding outwardly from the rotor core.

The switched reluctance motor assembly may further include a stator part receiving the rotor part therein, wherein the stator part includes a stator yoke receiving the rotor part therein and stator poles formed so as to correspond to the rotor poles and be spaced from the rotor poles and protruding inwardly of the stator yoke.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional perspective view of a switched reluctance motor assembly according to the present invention;

FIG. 2 is an exploded perspective view separately showing a lower balancing part and a sensing part according to the present invention;

FIG. 3 is an exploded perspective view separately showing a lower balancing part and a sensing part according to a preferred embodiment the present invention;

FIG. 4 is an exploded perspective view separately showing a lower balancing part and a sensing part according to another preferred embodiment the present invention;

FIG. 5 is an exploded perspective view separately showing a lower balancing part and a sensing part according to still another preferred embodiment the present invention;

FIGS. 6 and 7 are conceptual diagrams describing that slot interference of the sensing part may be prevented according to the present invention; and

FIG. 8 is a conceptual diagram showing a rotor part and a stator part according to the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

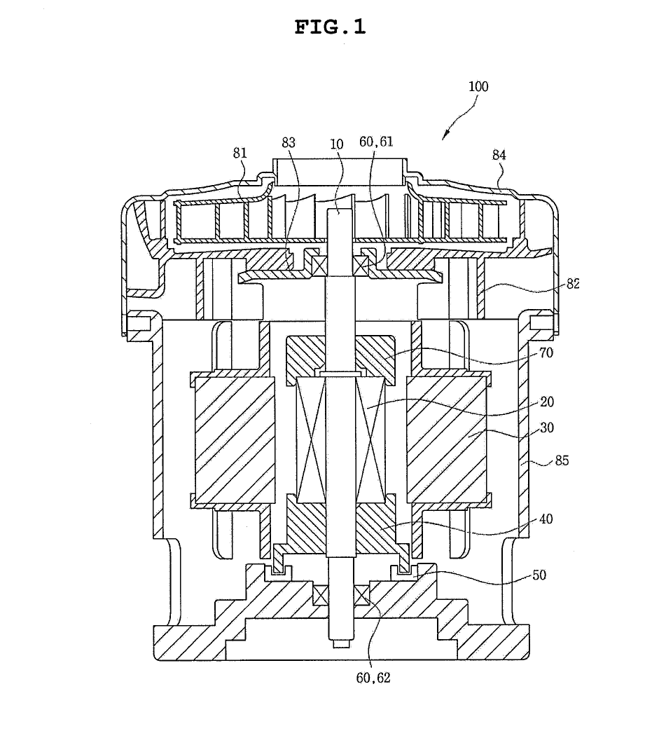

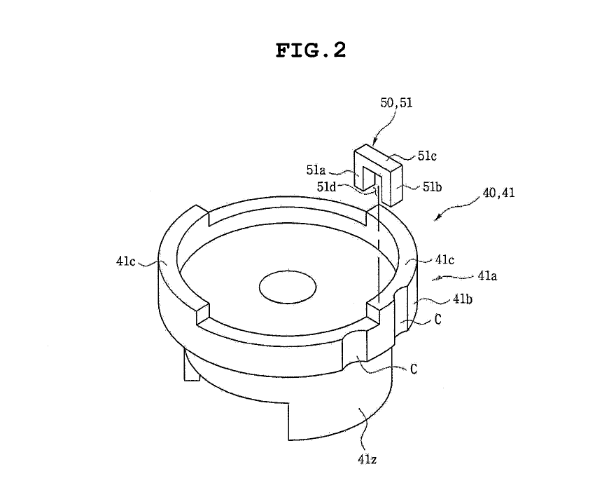

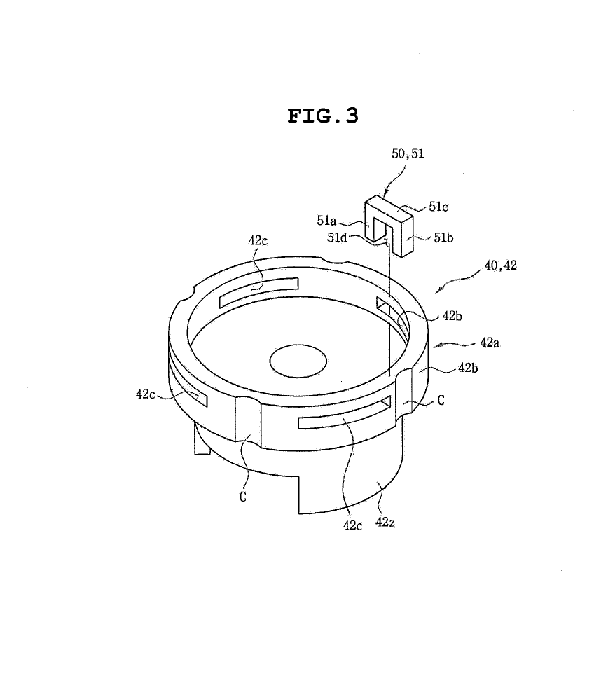

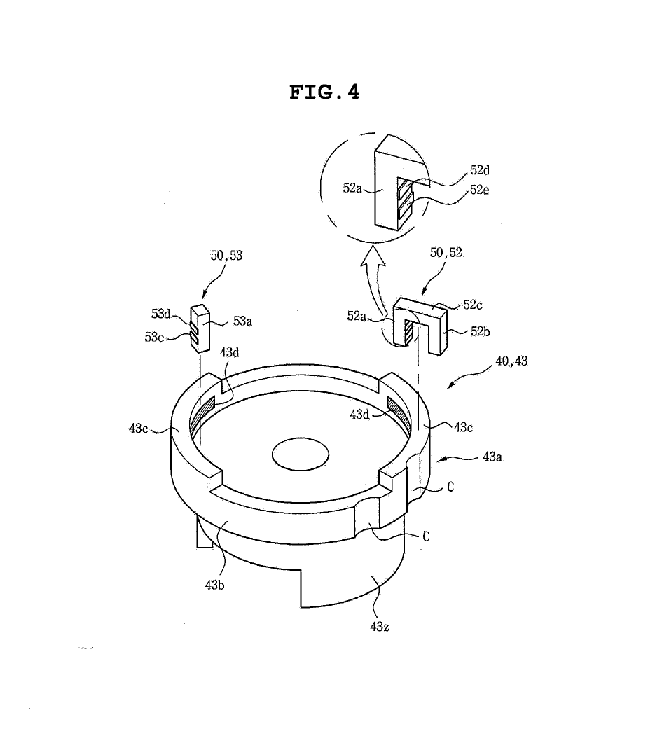

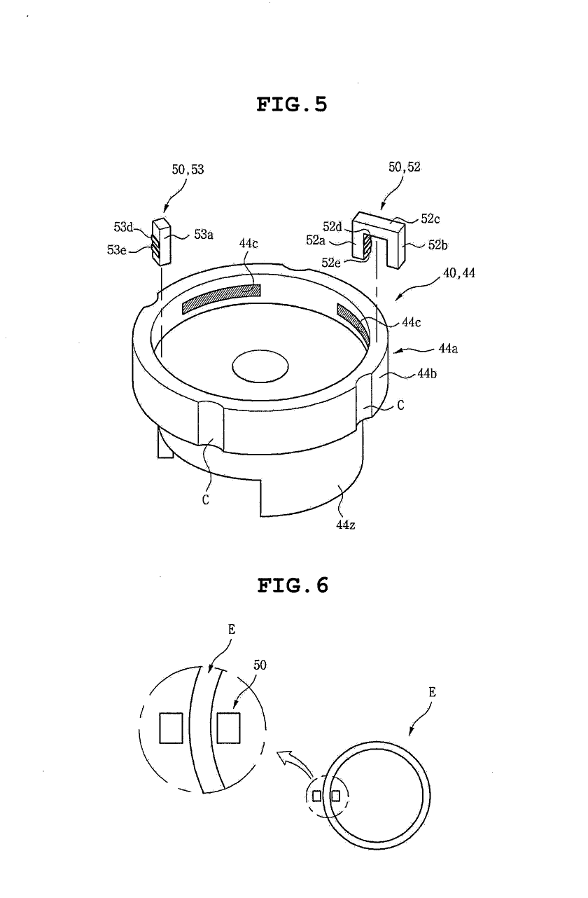

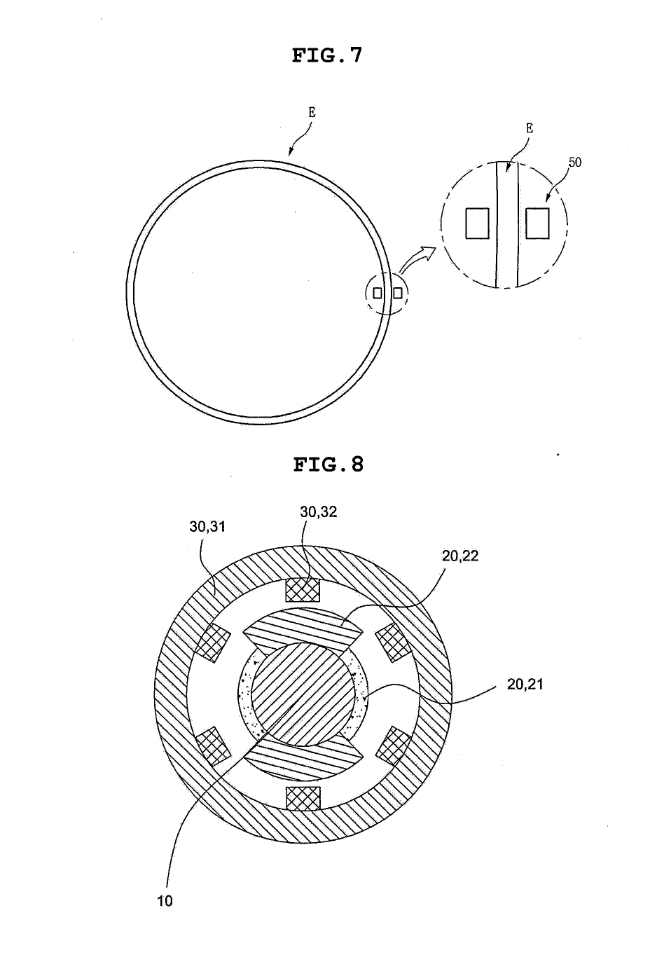

FIG. 1 is a cross-sectional perspective view of a switched reluctance motor assembly according to the present invention; FIG. 2 is an exploded perspective view separately showing a lower balancing part and a sensing part according to the present invention; FIG. 3 is an exploded perspective view separately showing a lower balancing part and a sensing part according to a preferred embodiment the present invention; FIG. 4 is an exploded perspective view separately showing a lower balancing part and a sensing part according to another preferred embodiment the present invention; FIG. 5 is an exploded perspective view separately showing a lower balancing part and a sensing part according to still another preferred embodiment the present invention; FIGS. 6 and 7 are conceptual diagrams describing that slot interference of the sensing part may be prevented according to the present invention; and FIG. 8 is a conceptual diagram showing a rotor part and a stator part according to the present invention.

As shown in FIG. 1, a switched reluctance motor assembly 100 according to the present invention may be configured to include a shaft 10 forming the center of rotation of a motor, a rotor part 20 rotatably coupled on the shaft 10, and an upper balancing part 70 and a lower balancing part 40 installed on upper and lower surfaces of the rotor part 20, respectively, as described above.

However, the lower balancing part 40 according to the present invention, which becomes a target to be cut for balancing, is different from the lower balancing part according to the prior art in that it includes a lower balancing part body installed on the lower surface of the rotor part and an encoder protruding on a lower surface of the lower balancing part body.

That is, the encoder according to the present invention is different from the encoder according to the prior art in that it is a portion of the lower balancing part 40 and becomes a target to be cut for the balancing. According to the prior art, the balancing part and the encoder are different components, only the balancing part becomes a target to be cut, and the encoder does not become the target to be cut, such that a large amount of cutting is required.

In the present invention that is to solve the above-mentioned problem, unlike the prior art, the encoder is a portion of the balancing part and becomes the target to be cut, such that the balancing may be promoted even with a small amount of cutting, which will be described below.

Meanwhile, the sensing part 50 may include a transmitting part and a receiving part spaced apart from each other so that the encoder passes therethrough. Hereinafter, the lower balancing part 40 and the sensing part 50 will be described in detail through the respective preferred embodiments.

However, the lower balancing part body and the encoder shown in FIGS. 2 to 5 are disposed in an opposite direction to that of FIG. 1. That is, although the case in which the encoder is disposed on the lower balancing part body is shown in FIGS. 2 to 5, the encoder is actually disposed on the lower surface of the lower balancing part body.

### Preferred Embodiment 1

The switched reluctance motor assembly according to the present invention is configured to include the shaft forming the center of rotation of the motor, the rotor part rotatably coupled on the shaft, the upper balancing part and the lower balancing part installed on the upper and lower surfaces of the rotor part, respectively, and the sensing part disposed at one side of the lower balancing part, as described above.

Here, the lower balancing part 41 according to the present embodiment, which becomes a target to be cut for the balancing, includes a lower balancing part body 41z installed on the lower surface of the rotor part and an encoder 41a protruding on a lower surface of the lower balancing part body 41z, as shown in FIG. 2.

The encoder 41a, which protrudes on the lower surface of the lower balancing part body 41z, may include a base 41b having a hollow cylindrical shape and having a radius larger than that of the lower balancing part body 41z and a plurality of slot blocking parts 41c protruding on a lower surface of the base 41b in a thickness direction, having an arc shape with a predetermined angle, and formed to be spaced apart from each other to pass through a slot 51d of the sensing part 51 to be described below.

The sensing part 51 may include a transmitting part 51a and a receiving part 51b spaced apart from each other so that the slot blocking part 41c of the encoder 51a passes therethrough as described above. That is, the slot blocking part 41c passes through the slot 51d, which is an empty space, formed between the transmitting part 51a and the receiving part 51b.

Here, in the case in which the slot blocking part 41c is positioned in the slot 51d, a signal is not transferred between the transmitting part 51a and the receiving part 51b, and in the case in which the slot blocking part 41c exits from the slot 51d, the signal is transferred between the transmitting part 51a and the receiving part 51b, thereby making it possible to recognize a position of a rotor core by a controlling part (not shown).

Meanwhile, the sensing part 51 may include a connecting part 51c connecting upper end portions of the transmitting part 51a and the receiving part 51b to each other and be disposed as shown in FIG. 1, which will be similarly applied to the following preferred embodiments. Therefore, an overlapped description will be omitted.

As described above, in the present embodiment, the encoder 41a, which is a portion of the balancing part, becomes the target C to be cut. Generally, since the encoder 41a has a radius larger than that of the lower balancing part body 41z as described above, the balancing may be promoted even with a small amount of cutting, which will be described below.

### Preferred Embodiment 2

The switched reluctance motor assembly according to the present invention is configured to include the shaft forming the center of rotation of the motor, the rotor part rotatably coupled on the shaft, the upper balancing part and the lower balancing part installed on the upper and lower surfaces of the rotor part, respectively, and the sensing part disposed at one side of the lower balancing part, as described above.

Here, the lower balancing part 42 according to the present embodiment, which becomes a target to be cut for the balancing, includes a lower balancing part body 42z installed on the lower surface of the rotor part 20 and an encoder 42a protruding on a lower surface of the lower balancing part body 42z, as shown in FIG. 3.

The encoder 42a, which protrudes on the lower surface of the lower balancing part body 41z, may include a base 42b having a hollow cylindrical shape and having a radius larger than that of the lower balancing part body 42z to pass through a slot of the sensing part 51 as described above and a plurality of slot communicating parts 42c disposed along a side of the base 42b in a circumferential direction, formed to penetrate through the base 42b by a predetermined length in the circumferential direction, and spaced apart from each other.

Unlike the preferred embodiment 1, in the preferred embodiment 2, a signal between the transmitting part 51a and the receiving part 51b of the sensing part 51 is transferred through the slot communicating part 42c. That is, in the case in which the slot communicating part 42c of the base 42b is disposed between the transmitting part 51a and the receiving part 51b of the sensing part 51, the signal may be transferred through the slot communicating part 42c. To the contrary, in the case in which the slot communicating part 42c of the base 42b is not disposed between the transmitting part 51a and the receiving part 51b of the sensing part 51, the base 42b blocks between the transmitting part 51a and the receiving part 51b of the sensing part 51, such that the signal is not transferred therebetween. The above-mentioned phenomenon is used, thereby making it possible to recognize a position of a rotor core by a controlling part (not shown).

Also in the present embodiment, as described above, the encoder 42a, which is a portion of the balancing part, becomes the target to be cut C, such that the balancing may be promoted even with a smaller amount of cutting as compared with the prior art.

Meanwhile, the slot communicating part 42c may have a rectangular cross section as shown. However, this is only an example of describing the slot communicating part 42c according to the present invention. That is, the slot communicating part 42c may have other shapes as long as the signal may be transferred between the transmitting part 51a and the receiving part 51b of the sensing part 51 as described above.

Since other components are the same as those of the previous embodiment, an overlapped description will be omitted.

### Third Preferred Embodiment

The switched reluctance motor assembly according to the present invention is configured to include the shaft forming the center of rotation of the motor, the rotor part rotatably coupled on the shaft, the upper balancing part and the lower balancing part installed on the upper and lower surfaces of the rotor part, respectively, and the sensing part disposed at one side of the lower balancing part, as described above.

Here, the lower balancing part 43 according to the present embodiment, which becomes a target to be cut for the balancing, includes a lower balancing part body 43z installed on the lower surface of the rotor part and an encoder 43a protruding on a lower surface of the lower balancing part body 43z, as shown in FIG. 4.

Here, the encoder 43a, which protrudes on the lower surface of the lower balancing part body 43z, may include a base 43b having a hollow cylindrical shape and having a radius larger than that of the lower balancing part body 43z and a plurality of slot blocking parts 43c protruding on a lower surface of the base 43b in a thickness direction, having an arc shape with a predetermined angle, formed to be spaced apart from each other, and having reflecting parts 43d formed on one side thereof.

That is, the encoder 43a according to the present embodiment includes the slot blocking part having the same shape as that of the slot blocking part of the encoder according to the preferred embodiment 1, but is different from the encoder according to the preferred embodiment 1 in that the above-mentioned reflecting part 43d is formed. In addition, the sensing part 52 is disposed at one side of the encoder 43a unlike the first preferred embodiment and includes a light emitting part 52d irradiating light to the reflecting part 43d and a detecting part 52d detecting light reflected from the reflecting part 43d.

In other words, the slot blocking part according to the first preferred embodiment allows the signal to be transferred or blocked while passing through the slot of the sensing part; however, the sensing part according to the present embodiment is disposed at one side of the encoder 43a to detect the reflected light.

As shown in FIG. 4, the sensing part 52 according to the present embodiment may be formed in a ∩ shape in which an opened portion (that is, a slot) thereof is directed toward the encoder 43a and have the light emitting part 52d and the detecting part 52e installed at one side of an inner portion thereof.

After the light emitted from the light emitting part 52d is irradiated to the reflecting part 43d, the light reflected from the reflecting part 43d is detected by the detecting part 52e, such that the position of the rotor core is recognized.

Meanwhile, the reflecting part 43d may be disposed at an inner side of the slot blocking part 43c. The reason is that a cutting portion C for the balancing may be formed at an outer side of the slot blocking part 43c.

The sensing part 52 may have the ∩ shape as described above or be a sensing part 53 having the light emitting part 53d and the detecting part 53e installed at one side of a bar shaped support 53a that is vertically disposed as shown in the left of FIG. 4.

Since other components are the same as those of the previous embodiment, an overlapped description will be omitted.

### Fourth Preferred Embodiment

The switched reluctance motor assembly according to the present invention is configured to include the shaft forming the center of rotation of the motor, the rotor part rotatably coupled on the shaft, the upper balancing part and the lower balancing part installed on the upper and lower surfaces of the rotor part, respectively, and the sensing part disposed at one side of the lower balancing part, as described above.

Here, the lower balancing part 44 according to the present embodiment, which becomes a target to be cut for the balancing, includes a lower balancing part body 44z installed on the lower surface of the rotor part and an encoder 44a protruding on a lower surface of the lower balancing part body 44z and having the reflecting part 44c formed on one side thereof, as shown in FIG. 5.

In addition, the sensing part 52, which is disposed at one side of the encoder 44a, may include a light emitting part 52d irradiating light to the reflecting part and a detecting part 52e detecting light reflected from the reflecting part 44c, as described above.

However, the encoder 44a, which protrudes on the lower surface of the lower balancing part body 44z, is different from the encoder according to the second preferred embodiment in that it includes the base 44b having a hollow cylindrical shape, having a radius larger than that of the lower balancing part body 44z, and having the reflecting part 44c formed on an inner side thereof.

That is, the encoder 44a according to the present embodiment has the same shape as that of the encoder according to the second preferred embodiment, but is different therefrom in that the reflecting part 44c is formed. After the reflecting part 44c reflects the light while the base 44b according to the present embodiment is rotated, the detecting part 52e of the sensing part 52 detects the light to recognize the position of the rotor core.

Further, in addition to the sensing part 52 having the 11 shape, a linear sensing part shown in the left of FIG. 5 may be used as described above.

Since other components are the same as those of the previous embodiment, an overlapped description will be omitted.

According to the present invention as described above, the balancing may be performed even with a small amount of cutting as compared with the prior art, which will be described below.

As generally well-known, a balancing effect is in proportion to a distance from the center. In other words, according to the present invention, when the encoder for recognizing the position of the rotor core is formed as a portion of the lower balancing part so as to have a diameter larger than that of the lower balancing part and the encoder is then cut, a distance of a cut portion increases, such that the balancing effect rises. As a result, the balancing may be promoted even with a smaller amount of cutting as compared with the prior art.

In addition, according to the present invention, since the encoder becomes distant from the center, an amount of encoder capable of closing a light path at the same time increases as compared with the prior art, such that a sensor recognition rate is more stable as compared with the structurally same dimension error range. This effect is further improved at a high speed.

That is, for example, in FIG. 2, a circumference length of the encoder, more specifically, the slot blocking part 41c increases as the diameter of the encoder 41a increases based on the same angle. Therefore, as described above, the amount of encoder capable of closing the light path increases.

In addition, according to the present invention, since the encoder has the diameter increased as compared with the prior art, it has a shape similar to a linear shape, such that a risk that it will interfere with the slot of the sensing part decreases.

That is, as shown in FIG. 6, according to the prior art, when an encoder E having a small radius passes between the sensing parts 50, the interference possibility increases. However, as shown in FIG. 7, according to the present invention, since the encoder E has an increased radius to have a shape similar to that of a linear shape, when the encoder passes between the sensing parts 50, the interference probability relatively decreases.

Meanwhile, the lower balancing part according to the present invention includes the lower balancing part body and the encoder as described above. In this case, the lower balancing part body and the encoder may also be formed integrally with each other by injection-molding.

The switched reluctance motor assembly 100 according to the present invention as described above is configured to include the rotor part 20, an upper bearing part 61 coupled to an upper portion of the upper balancing part 70 disposed on the rotor part 20, a lower bearing 62 disposed on a lower portion of the lower balancing part 40, a front part 83 supporting the upper bearing 61, a diffuser part 82 coupled to an upper portion of the front part 83, and an impeller part 82 coupled to an upper portion of the diffuser part 82 and coupled to the shaft 10, as shown in FIG. 1.

In addition, the switched reluctance motor assembly 100 according to the present invention may include a housing part 85 enclosing an outer side of the rotor part 20 and formed to include the upper bearing 61 and the lower bearing 62 and a cover part 84 coupled to an upper portion of the housing part 85.

The diffuser part 82 allows pressure of air sucked in by the impeller part 81 to rise. The air of which the pressure rises is supplied through a space formed between an inner peripheral surface of the housing part 85 and an outer peripheral surface of the diffuser part 82, is guided to a central portion, and is then blown from the motor, such that the air is discharged while cooling the motor.

The housing part 85 is formed at outer sides of the rotor part 20, the upper and lower balancing parts 70 and 40, and the like, so as to be spaced apart from the rotor part 20, the upper and lower balancing parts 70 and 40, and the like, and to enclose the rotor part 20, the upper and lower balancing parts 70 and 40, and the like, as described above. The housing part 85 structurally protects components received therein, such as the rotor part 20, the stator part 30, and the like, and prevents other foreign materials from being introduced from the outside thereinto, thereby making it possible to improve reliability in an operation of the motor.

The cover part 82 is coupled to the upper portion of the housing part 85, as shown in FIG. 1. Here, the cover part 84 coupled to the impeller part 81 serves to cover the upper portion of the housing part 85 and at the same time, adjusts an upper coupling height of the impeller part 81, thereby making it possible to improve efficiency of the motor. To this end, an outer edge of the housing part 85 is provided with a step part (not shown), thereby making it possible to improve reliability of a coupling height at the time of coupling between the cover part 84 and the housing part 85.

As shown in FIG. 8, the rotor part 20 may include an annular rotor core 21 and a plurality of rotor poles 22 protruding outwardly from the rotor core 21. Here, the rotor core 21 has a hollow hole formed at a central portion thereof, and the shaft 10 is fixedly coupled to the hollow hole to transfer rotation of the rotor part 20 to the outside. The plurality of rotor poles 22 may be formed to protrude outwardly along an outer circumferential surface of the rotor core 21 and be formed to correspond to stator poles 32 to be described below.

Meanwhile, the stator part 30 may include a stator yoke 31 and stator poles 32 as shown. The stator yoke 31 may include a hollow hole formed therein so as to receive the rotor part 20 therein, and a plurality of stator poles 32 may be formed to protrude from an inner surface of the stator yoke 31 and correspond to the rotor poles 22 of the rotor part 20. Here, a current is applied to the stator poles 32 of the stator yoke 31 to form a magnetic flux path through the stator poles 32 and the rotor poles 22 of the rotor part 20 facing the stator poles 32, such that the rotor part 20 rotates.

As set forth above, according to the preferred embodiment of the present invention, the encoder for recognizing the position of the rotor core is formed as a portion of the lower balancing part, thereby making it possible to promote the balancing even with a smaller amount of cutting as compared with the prior art.

In addition, the encoder is used as a balancing member, thereby making it possible to omit components of a separate balancing member, and an outer side of the encoder having a relatively large diameter is cut, thereby making it possible to more effectively perform the balancing even with a smaller amount of cutting.

Further, the encoder is used as the balancing member to effectively perform the balancing, thereby making it possible to operational performance and reliability of driving of the motor.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switched reluctance motor assembly comprising:
a shaft forming the center of rotation of a motor;
a rotor part rotatably coupled on the shaft;
an upper balancing part and a lower balancing part installed on upper and lower surfaces of the rotor part, respectively; and
a sensing part disposed at one side of the lower balancing part,
wherein the lower balancing part, which becomes a target to be cut for balancing, includes a lower balancing part body installed on the lower surface of the rotor part and an encoder protruding on a lower surface of the lower balancing part body, and
the sensing part including a transmitting part and a receiving part spaced apart from each other so that the encoder passes therethrough.

2. A switched reluctance motor assembly comprising:
a shaft forming the center of rotation of a motor;
a rotor part rotatably coupled on the shaft;
an upper balancing part and a lower balancing part installed on upper and lower surfaces of the rotor part, respectively; and
a sensing part disposed at one side of the lower balancing part,
wherein the lower balancing part, which becomes a target to be cut for balancing, includes a lower balancing part body installed on the lower surface of the rotor part and an encoder protruding on a lower surface of the lower balancing part body and having reflecting parts formed on one side thereof, and
the sensing part is disposed at one side of the encoder and includes a light emitting part irradiating light to the reflecting part and a detecting part detecting light reflected from the reflecting part.

3. The switched reluctance motor assembly as set forth in claim 1, wherein the encoder, which protrudes on the lower surface of the lower balancing part body, includes:
a base having a hollow cylindrical shape and having a radius larger than that of the lower balancing part body; and
a plurality of slot blocking parts protruding on a lower surface of the base, having an arc shape with a predetermined angle, and formed to be spaced apart from each other to pass to through a slot of the sensing part.

4. The switched reluctance motor assembly as set forth in claim 2, wherein the encoder, which protrudes on the lower surface of the lower balancing part body, includes:
a base having a hollow cylindrical shape and having a radius larger than that of the lower balancing part body; and
a plurality of slot blocking parts protruding on a lower surface of the base, having an arc shape with a predetermined angle, formed to be spaced apart from each other, and having reflecting parts formed on one side thereof.

5. The switched reluctance motor assembly as set forth in claim 1, wherein the encoder, which protrudes on the lower surface of the lower balancing part body, includes:
a base having a hollow cylindrical shape and having a radius larger than that of the lower balancing part body to pass through a slot of the sensing part; and
a plurality of slot communicating parts disposed along a side of the base in a circumferential direction, formed to penetrate through the base by a predetermined length in the circumferential direction, and spaced apart from each other.

6. The switched reluctance motor assembly as set forth in claim 2, wherein the encoder, which protrudes on the lower surface of the lower balancing part body, includes a base having a hollow cylindrical shape, having a radius larger than that of the lower balancing part body, and having the reflecting part formed on an inner side thereof.

7. The switched reluctance motor assembly as set forth in claim 1, further comprising:
an upper bearing part coupled to an upper portion of the upper balancing part disposed on the rotor part;
a lower bearing coupled to a lower portion of the lower balancing part;
a front part supporting the upper bearing;
a diffuser part coupled to an upper portion of the front part; and
an impeller part coupled to an upper portion of the diffuser part and coupled to the shaft.

8. The switched reluctance motor assembly as set forth in claim 7, further comprising:
a housing part enclosing an outer side of the rotor part and formed to include the upper bearing and the lower bearing; and
a cover part coupled to an upper portion of the housing part.

9. The switched reluctance motor assembly as set forth in claim 1, wherein the lower balancing part and the encoder are formed integrally with each other by injection-molding.

10. The switched reluctance motor assembly as set forth in claim 1, wherein the rotor part includes an annular rotor core and a plurality of rotor poles protruding outwardly from the rotor core.

11. The switched reluctance motor assembly as set forth in claim 10, further comprising a stator part receiving the rotor part therein,
wherein the stator part includes a stator yoke receiving the rotor part therein and stator poles formed so as to correspond to the rotor poles and be spaced from the rotor poles and protruding inwardly of the stator yoke.
